(19) United States
(12) Patent Application Publication
(10) Pub. No.: US 2025/0296279 A1
(43) Pub. Date: Sep. 25, 2025

(54) A MULTI-ADAPTABLE MELT ELECTROWRITING SYSTEM AND METHOD OF USING THE SAME

(71) Applicant: Ohio State Innovation Foundation, Columbus, OH (US)

(72) Inventors: David Dean, Columbus, OH (US); Ciro Angel Rodriguez Gonzalez, Columbus, OH (US); Javier Oswaldo Vazquez Armendariz, Columbus, OH (US); Raquel Tejeda Alejandre, Columbus, OH (US)

(21) Appl. No.: 18/863,518

(22) PCT Filed: May 5, 2023
(86) PCT No.: PCT/US2023/066648

§ 371 Date: Nov. 6, 2024

Related U.S. Application Data
(60) Provisional application No. 63/364,277, filed on May 6, 2022.

(51) Int. Cl. B29C 64/118; B29C 64/209; B29C 64/241; B29C 64/245; B29C 64/295; B33Y 10/00; B33Y 30/00

(52) U.S. Cl. CPC B29C 64/118; B29C 64/209; B29C 64/241; B29C 64/245; B29C 64/295; B33Y 10/00; B33Y 30/00

(57) ABSTRACT

A melt electrowriting (MEW) system includes an MEW device configured to print a material on a collector. The MEW device includes a print head configured to melt and extrude the material out from an extruder. The extruder is exchangeable depending on a surface profile of the collector. The MEW device includes a positioning system configured to coordinate movements of the collector relative to the print head. The MEW system is configured to print the material with at least four mechanical degrees of freedom and up to six mechanical degrees of freedom.

### PRIOR RELATED APPLICATIONS

The present application claims the priority to U.S. Provisional Application No. 63/364,277, filed on May 6, 2022, entitled Development of a Multi-adaptable Melt Electrowriting Print-Head for Tissue Engineering Applications, which is incorporated herein in its entirety.

### FIELD OF INVENTION

The present disclosure generally relates to a multi-adaptable melt electrowriting system and method of using the same. More specifically, the present disclosure relates to a multi-adaptable melt electrowriting system for printing on curved surfaces.

### BACKGROUND

An emerging polymer fiber-forming, additive manufacturing technique, “Melt Electrowriting” (MEW), has proven to provide great advantages in micro-scale manufacturing. The MEW technique consists of the ordered deposition of microfibers of a molten polymer on a collecting surface. The MEW technique requires first melting and then ejection of a polymer in a controlled process through an extruder. An electric field is then applied between the polymer being extruded and the collector surface (usually made of electrically conductive materials) so that the resulting fiber is deposited in a defined trajectory. The MEW technology has been applied in numerous fields. For example, the MEW technology has been used to fabricate auxetic stretchable force sensor for hand rehabilitation made with polymer (polycaprolactone) in electronics applications, Isomalt micro-channels in microfluidic applications, liquid refractive index-sensing chip in patterned optical device applications, and incorporation of hybrid organic-inorganic perovskite into poly (styrene) fibers in solar cell applications. In addition, the most relevant applications of MEW have been developed in the area of Tissue Engineering for the biofabrication of scaffolds, mainly flat and straight tubes. Despite the tremendous development, many challenges remain, especially in biofabrication applications involving tortuous curving structures.

### SUMMARY

A melt electrowriting (MEW) system includes an MEW device configured to print a material on a collector. The MEW device includes a print head configured to melt and extrude the material out from an extruder. The extruder is exchangeable depending on a surface profile of the collector. The MEW device includes a positioning system configured to coordinate movements of the collector relative to the print head. The MEW system is configured to print the material with at least four mechanical degrees of freedom and up to six mechanical degrees of freedom.

Other elements of the MEW system include a trunnion mechanism integrated with the positioning system to enable rotations of the collector relative to the print head along a yaw axis and along a roll axis, or along the pitch axis and along the roll axis. The print head is integrated in a Z axis of the positioning system. The trunnion mechanism is integrated in a XY axis of the positioning system. The extruder is exchangeable between a flat extruder configured to print on a flat surface profile and a conical extruder configured to print on a curved surface profile.

Other elements of the MEW system include a six-axis collaborative robot coupled to the print head to move the print head relative to the collector, or vice versa if needed, with up to six mechanical degrees of freedom. The positioning system is configured to maintain an orthogonal print head-collector relationship with out-of-plane collector surfaces. The print head includes a syringe with a needle configured to contain the material; a heating chamber configured to receive the syringe and the needle and provide heat to the syringe and the needle via cartridge heaters; and a thermally insulative layer that wraps around the heating chamber.

Other elements of the MEW system include the MEW system is configured to print the material on the collector with geometries of a lattice base for cornea, bifurcated vascular grafts, knee cartilage, or curved surfaces. The MEW system is capable of printing on the collector of a curving tubular structure. The MEW system is capable of printing on the collector of a non-circular cross-sectional tubular structure. The MEW system is capable of printing on the collector of a bifurcating tubular structure. The MEW system is capable of printing membranes with pore sizes as small as about 10 μm.

A process of melt electrowriting (MEW) on a collector using a MEW system is provided. The MEW system includes a print head configured to melt and extrude a material out from an extruder, and a positioning system configured to coordinate movements of the collector relative to the print head. The process includes swapping a flat extruder with a conical extruder and printing on out-of-plane collector surfaces. The process includes maintaining an orthogonal print head-collector relationship with the out-of-plane collector surfaces during printing.

The process includes rotating the collector relative to the print head along a yaw axis and along a roll axis, or along the pitch axis and along the roll axis during printing using a trunnion mechanism integrated with the positioning system. The process includes moving the print head relative to the collector, or vice versa, with up to six mechanical degrees of freedom during printing using a six-axis collaborative robot coupled to the print head.

The process includes printing on the collector of a curving tubular structure, printing on the collector of a non-circular cross-sectional tubular structure, printing on the collector of a bifurcating tubular structure, and printing on the collector with geometries of a lattice base for curving organ surfaces comprising bifurcated vascular grafts, knee cartilage, and/or other curved surfaces.

### BRIEF DESCRIPTION OF THE DRAWINGS

FIG. 1 is a block diagram of an example MEW system;

FIG. 2 is a perspective view of an example MEW system;

FIG. 3A is a perspective view of an example print head and its housing structure;

FIG. 3B is a perspective view of an example print head;

FIG. 3C is a front view of an example print head with a flat extruder;

FIG. 3D is a front view of an example print head with a conical extruder;

FIG. 3E is a sectional view of an example heating chamber;

FIG. 3F shows a top view and a bottom view of the heating chamber of FIG. 3E;

FIG. 3G is a perspective view of the heating chamber of FIG. 3E;

FIG. 3H shows a front view of an example flat interchangeable ring in the flat extruder of FIG. 3C and a front view of an example conical interchangeable ring in the conical extruder of FIG. 3D;

FIG. 4 is a diagram showing an example hardware architecture of a MEW system;

FIGS. 5A-5D each is a perspective view of an example MEW system having an example trunnion mechanism coupled to a positioning system to increase printing rotational freedom.

FIG. 6A is a perspective view of an example MEW system having an example trunnion mechanism coupled to a positioning system to print on a collector with a geometry of a knee cartilage;

FIG. 6B shows an example of membranes printed on the collector of FIG. 5A;

FIG. 6C is a perspective view of an example MEW system having an example trunnion mechanism coupled to a positioning system to print on a collector with a geometry of bifurcated tubes.

FIG. 6D is a perspective view of the print head and the collector of FIG. 6C in an orthogonal relationship;

FIG. 7 is a perspective view of an example MEW system with an example robot coupled to the print head; and

FIG. 8 shows example configurable collectors in a perspective view.

### DETAILED DESCRIPTION

The present disclosure is not limited in terms of the particular embodiments described in this application, which are intended as illustrations of various aspects only. Many modifications and variations can be made without departing from the scope of the invention, as will be apparent to those skilled in the art. Functionally equivalent methods within the scope of the disclosure, in addition to those enumerated herein, will be apparent to those skilled in the art from the following descriptions. Such modifications and variations are intended to fall within the scope of the appended claims. The terminology used herein is for the purpose of describing particular embodiments only and is not intended to be limiting.

The present disclosure generally relates to a multi-adaptable melt electrowriting (MEW) system. More specifically, the present disclosure relates to a multi-adaptable MEW print head and three-dimensional (3D) configurable collectors and kinematics, which are optimized to work with MEW.

The MEW technique consists of the ordered deposition of microfibers of a molten polymer on a collecting surface. The novel print head uses previously established technology in that it first melts and then ejects a polymer in a controlled process through an extruder. An electric field is applied between the polymer being extruded and the collector surface (usually made of electrically conductive materials), so that the resulting fiber is deposited in a defined trajectory.

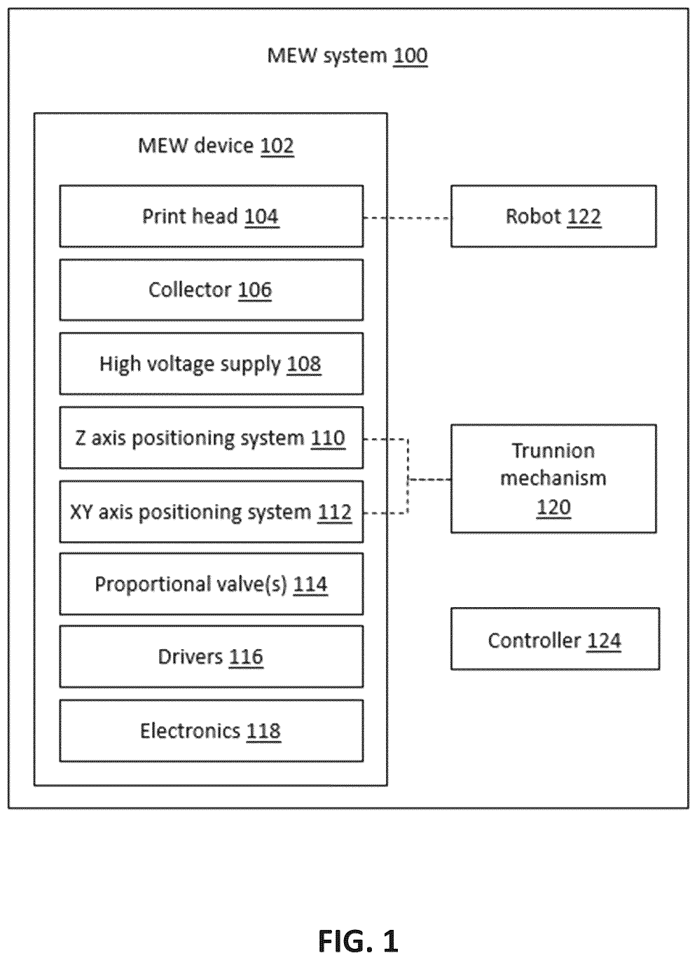

FIG. 1 shows a block diagram of an example melt electrowriting (MEW) system 100. The MEW system 100 includes a MEW device 102 that includes systems and components (e.g., voltage supply, pressure valve, heating system, electronics, positioning system, etc.) needed to melt and then eject a polymer in a controlled process through a print head 104 and deposited on a collector 106. For example, the MEW system 100 includes a high voltage supply 108, a Z axis positioning system 110, a XY axis positioning system 112, proportional valve(s) 114, drivers 116, and electronics 118 for heating control, temperature sensing, power supplies, the proportional valve(s) 114, the drivers 116, etc.

The print head 104 in the MEW system 100 disclosed herein may be a multi-adaptable print head configured with improved safety and adaptability for printing on plane surfaces and over out-of-plane or curved surfaces.

Furthermore, the MEW system 100 disclosed herein include mechanisms configured to increase the printing rotational freedom. In one embodiment, the MEW system 100 includes a trunnion mechanism 120 in addition to the positioning system (the Z axis positioning system 110 coupled to the print head 104 and the XY axis positioning system 112 coupled to the collector 106). The incorporation of the trunnion mechanism 120 enables additional 1 or 2 rotational axes (additional 1 or 2 mechanical degrees of freedom) to the collector positioning system in comparison to a conventional MEW system without the trunnion mechanism 120. The additional rotational freedom enables printing on a curved, non-circular cross-sectional and/or bifurcating tubular collectors 106. In another embodiment, the MEW system 100 includes a robot 122 (e.g., a 6-axis collaborative robot) configurable to position/move the print head 104 to provide up to 6 mechanical degrees of freedom to enable printing on a configurable collector 106 with complex three-dimensional (3D) structures. In this embodiment, the robot 122 functions as a part of the positioning system. For example, the XY-Z axis positioning system is replaced by the robot 122

The MEW system 100 includes a controller 124 configured to operate and coordinate various components and systems in the MEW system 100. For example, the controller 124 is communicatively and operatively connected to the MEW device 102 and the robot 122 to coordinate printing. For example, the controller 124 is communicatively and operatively connected to the electronics 118 for the heating control, temperature sensing, power supplies, proportional valve, etc. The controller 124 may include any suitable processer (e.g., microprocessor, MOSFET, IGBT, etc.) and memory. The controller 124 may include any suitable user interface and/or display to allow a user to program and/or provide inputs to control the operation of the MEW system 100. The controller 124 may receive instructions from a user or may be pre-programmed to print following certain procedures or predetermined procedures.

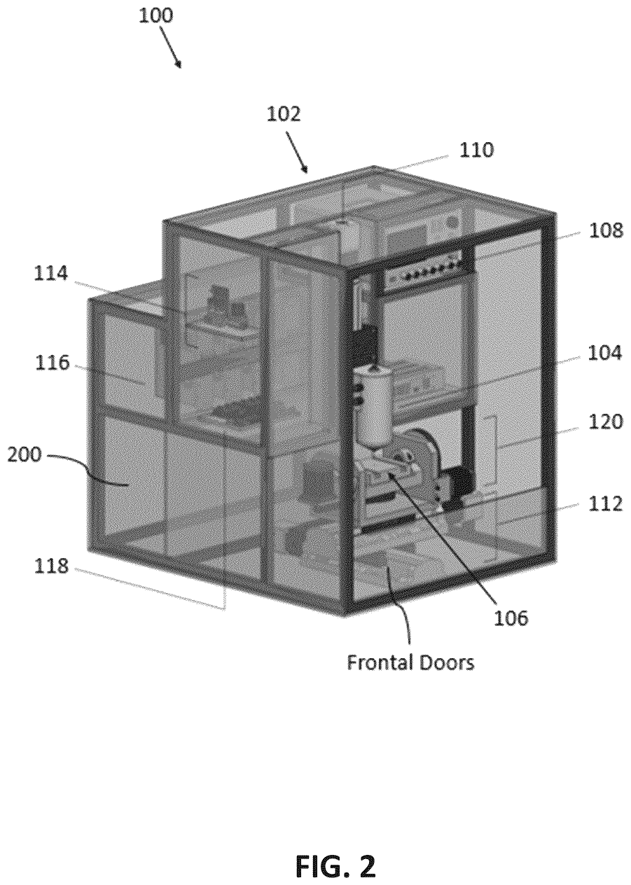

FIG. 2 shows an example MEW system 100 in a perspective view. In the illustrated embodiment, the print head 104 is mounted on the Z axis (e.g., the Z axis positioning system 110). The print bed (e.g., the collector 106 or a platform configured to receive the collector 106) is located on the trunnion mechanism 120 and the collector 106 is mounted on the XY axis (e.g., the XY axis positioning system 112). The trunnion mechanism 120 are integrated with the XY axis (e.g., the XY axis positioning system 112). The electric circuit 118 for the heating control, temperature sensing, power supplies, proportional valve, drivers, etc. are enclosed inside the MEW device 102, so they are safe from electrical fields. The MEW device 102 may be mounted on a granite table to avoid possible fiber pulsing from the motor's movement. The MEW system 100 includes a structure or housing structure 200 configured to entirely or partially enclose the MEW system 100. The structure 200 may include frontal doors to facilitate access to the MEW device 102 and to protect the users. The structure 200 may be transparent or at least partially transparent so the MEW system 100 and the printing process are visible from outside the structure 200. In the illustrated embodiment, the structure 200 is built with 2020-serie aluminum profiles (Iverntech, Seattle, WA), and is covered with acrylic sheets as isolator against high voltage. The frontal doors are made with the same materials (2020-serie aluminum profiles and acrylic sheets).

It is well known that the print head is a key element in any viable MEW system, as it must be able to provide constant extrusion pressure and heat to get an ordered deposition of fibers. Conventionally, a print head may include a heating chamber that recirculates hot air from a heat gun, or hot water from a recirculating water tank to melt the polymer for MEW. Unless a robust control of temperature variation is achieved, the semi-melted polymer may clog along the needle. Unless fine pressure control is achieved, the pneumatic system for material extrusion may leak. These limitations impede the orderly printing of fibers. To address this, the print head 104 disclosed herein is configured to have integrated closed-loop controlled electric cartridge heaters and custom-fabricated parts for inserting standard pneumatic couplings. These components are easy to access and manufacture using rapid manufacturing processes, so such solution could be easily adopted into the MEW system 100.

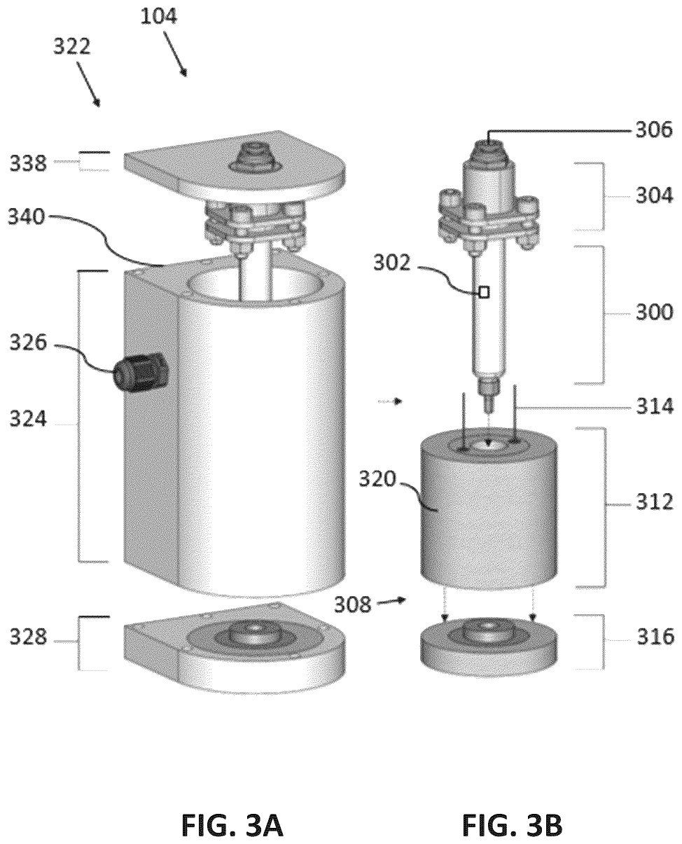

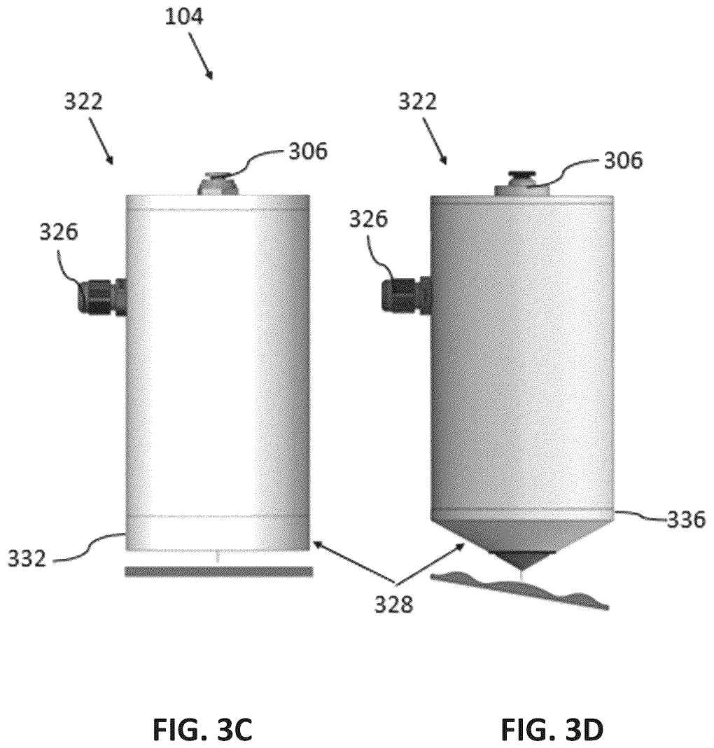

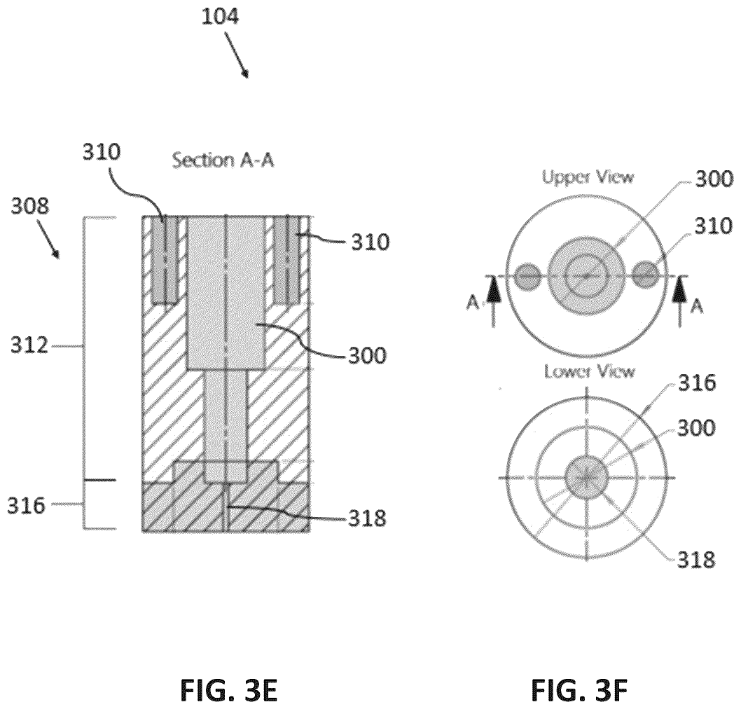

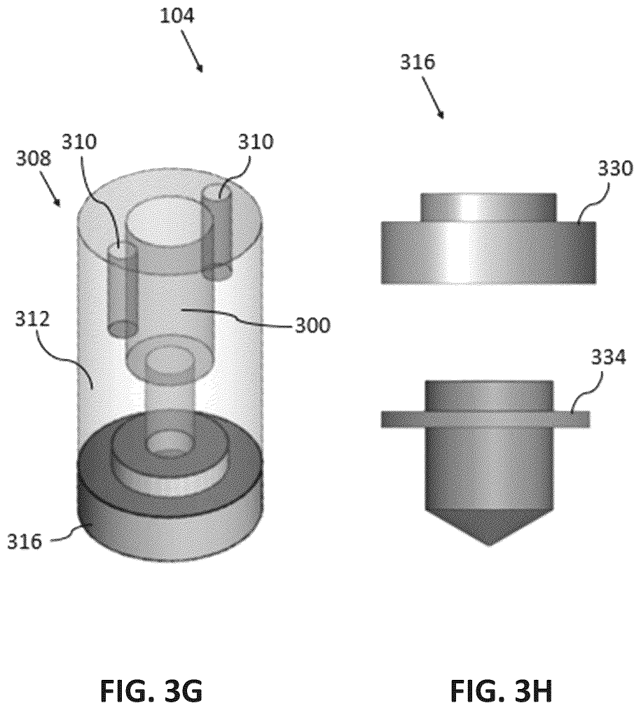

FIGS. 3A-3H show an example of the print head 104 in different views. The print head 104 includes a container or syringe 300 configured to contain polymer that is to be printed as the polymer is melted. The container 300 may be made of any suitable materials and shapes to allow ejection of a molten polymer. In the illustrated embodiment, the container 300 is a standard 10-milliliter (mL) luer-lock glass syringe (Grainger®, Lake Forest, IL).

The print head 104 includes a temperature sensor 302 incorporated, embedded, adhered, or attached to the syringe 300 to ensure an on-site measuring of the polymer's temperature. The temperature sensor 302 may be any suitable temperature sensor, for example, a high-temperature resistant coupling fits into the syringe 300 and embeds an NTC-100 kiloohm (kΩ) thermistor for melt temperature measurement (EI Sensor Technologies®, Anaheim, CA).

The print head 104 includes a coupling mechanism 304 configured to couple the syringe 300 to a pneumatic connector 306 and to fit an air pipe. For example, the pneumatic connector 306 may be a push-to-connect pneumatic quick connector (PneumaticPlus®, Torrance, CA) to fit a polyurethane air pipe (Grainger®, Lake Forest, IL). The coupling delivers air pressure to the syringe 300, thus extruding the molten polymer.

The print head 104 includes a heating chamber 308 and cartridge heaters 310 inserted in respective holes on the periphery of the heating chamber 308. The heating chamber 308 and the cartridge heaters 310 are configured to provide and trap heat within the heating chamber 308. The heating chamber 308 may be made of any suitable materials, shapes, and dimensions to receive the syringe 300. In the illustrated embodiment, the heating chamber 308 is made of 6026 aluminum (La Paloma S. A. de C.V®, Nuevo Leon, Mexico).

The heating chamber 308 includes a main body 312 configured to heat the syringe 300, thus melts the contained polymer. Holes 314 (e.g., two holes, three holes, four holes, etc.) on the periphery of the heating chamber 308 are configured to receive the cartridge heaters 310. The cartridge heaters 310 may be any suitable type of heater, for example, a 40-watt cartridge heater (SIMAX3D®, Shenzhen, China).

The print head 104 includes an interchangeable ring 316 configured to fit the needle 318 (of the syringe 300) and the lower part of the heating chamber 308. The interchangeable ring 316 allows keeping heat in the needle 318. Different types of rings are designed in order to fit a range of needle gauges from G14 to G30, which could provide the capability of using polymers with diverse rheological properties.

The print head 104 includes a thermally insulative layer 320 configured to cover the heating chamber 308 to prevent the risk of burns. The thermally insulative layer 320 can be made of any suitable materials. In the illustrated embodiment, the thermally insulative layer 320 is a high-temperature fiberglass wrap (SunPlus Trading Inc®, Pomona, CA).

The print head 104 includes a housing 322 configured to enclose the thermally insulative layer 320 wrapped heating chamber 308. The housing 322 serves not only for aesthetic purposes but also to protect the user from burns. Components and parts of the housing 322 may be manufactured via any suitable methods and materials. In the illustrated embodiment, the housing 322 is additively manufactured in acrylonitrile butadiene styrene (ABS-M30, Stratasys®, Rehovot, Israel). The housing 322 includes a main housing 324 configured to contain the heating chamber 308. The housing 322 includes an adjustable cable gland 326 on the side for quick and easy detachment of thermistor or heater cables. The housing 322 includes a lower housing 328 that is removable from the main housing 324 and is configured/shaped to accommodate the interchangeable ring 316 and the needle 318.

The interchangeable ring 316 and the lower housing 328 together function as an interchangeable/swapable extruder. The interchangeable ring 316 and the corresponding lower housing 328 are designed with two geometries. A flat extruder is formed by a flat interchangeable ring 330 and correspondingly a flat lower housing 332 configured for printing fibers in a plane or flat surfaces. A conical extruder is formed by a conical interchangeable ring 334 and correspondingly a conical lower housing 336 configured to avoid collisions with the collector (the collector 106 or the configurable collector) during printing over out-of-plane and curved surfaces. The interchangeability of the two extruders allows the flexibility and adaptability of the print head 104 to print on different surface profiles (e.g., flat, out-of-plane, curved).

The housing 322 includes a lid 338 that is removable from the main housing 324 to allow access to change the syringe 300 if needed. The housing 322 has a back side 340 that contains inserts for screws (e.g., M6 screws) so it could be attached to a mount to the Z axis positioning system 110 or attached to an end effector of the robot 122.

The components of the housing 322 are magnetically attached to each other, so it is easy to remove them to change syringes (the syringe 300), rings (the flat interchangeable ring 330 and the conical interchangeable ring 334), the flat extruder, the conical extruder, the lid 338, or adding new/different polymers.

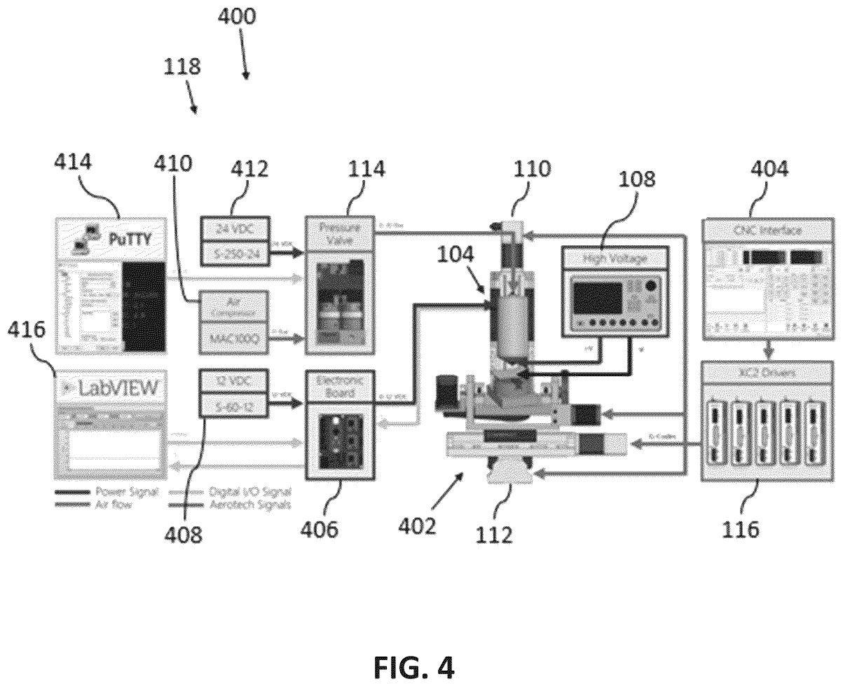

FIG. 4 shows an example hardware architecture 400 of the MEW device 102. The hardware architecture 400 includes three linear guides (high-resolution ECO115SL linear guides) and the trunnion system controlled by the five drivers 116 (Automation1 XC-2 drivers available from Aerotech®, Pittsburgh, PA), integrating the MEW device 102 positioning system (the Z axis positioning system 110, the XY axis positioning system 112, and the trunnion mechanism). An operator interface 404 (Aerotech's CNC Operator Interface) is used to control the toolpaths with G-codes. The print head 104 is coupled to the linear guide 402 that corresponds to the Z axis of the MEW device 102. The collector 106 is coupled to the linear guides 402 that correspond to the XY axis of the MEW device 102. The surface of the collector 106 functions as a print-bed.

The hardware architecture 400 includes an electronic board 406 controlled by any suitable electronics platform, such as Arduino Mega 2560® (Piedmont, Italy). The electronic board 406 is configured to control the modulation of heating. The electronic board 406 is configured to integrate with the temperature sensor 302 (the thermistor) for the polymer temperature measuring. The electronic board 406 is configured to integrate with transistors (IRF640N metal oxide semiconductor field-effect transistors available from Infineon Technologies AG®, Neubiberg, Germany) to modulate the voltage supplied to the cartridge heaters 310. The electronic board 406 is configured to integrate optocouplers (4N35 optocouplers available from Vishay Intertechnology Inc, Malvern, PA) as a safety barrier for the logic and power signals between the microcontroller and the heaters (the cartridge heaters 310). The electronic board 406 is configured to integrate with a power supply 408 (a S-60-12 power supply available from Alitove®, Shenzen, China) to provide the voltage required by the electronic board 406.

The air required to extrude the polymer along the syringe 300 comes from a compressor 410 (MAC100Q Quiet-Series compressor available form Makita®, Anjo, Japan). The air pressure is regulated by the proportional valve 114 (Cordis® CPC-C-F-R-N-A high resolution proportional pressure valve available from Clippard®, Cincinnati, OH). A power supply 412 (S-250-24 available from Alitove®, Shenzen, China) is used to provide the voltage required by the valve (the proportional valve 114), and software 414 (the open-source software PUTTY) is utilized to control it by serial communication.

A visual interface and a Proportional-Integrative-Derivate control (PID) are implemented in a system-design platform and development environment 416 (Lab VIEW 2021 available from National Instruments®, Austin, TX) to control the heating temperature. At the beginning of the heating, the data read by the temperature sensor 302 (the thermistor) is sent to the microcontroller to be displayed in the visual interface. At the same time, it is processed by the PID control to activate the cartridge heaters 310 in the electronic board 406 through Pulse Width Modulation signals (PWM). In this way the polymer temperature is stable during the printing process.

To produce the electromagnetic field, the high voltage supply 108 (ES20 high voltage power supply available from Gamma®, Ormond Beach, FL, USA) is used. Electrically insulative pipes (polyurethane pipes available from Grainger, Lake Forest, IL) are added to cover all the wires exposed to the high voltage.

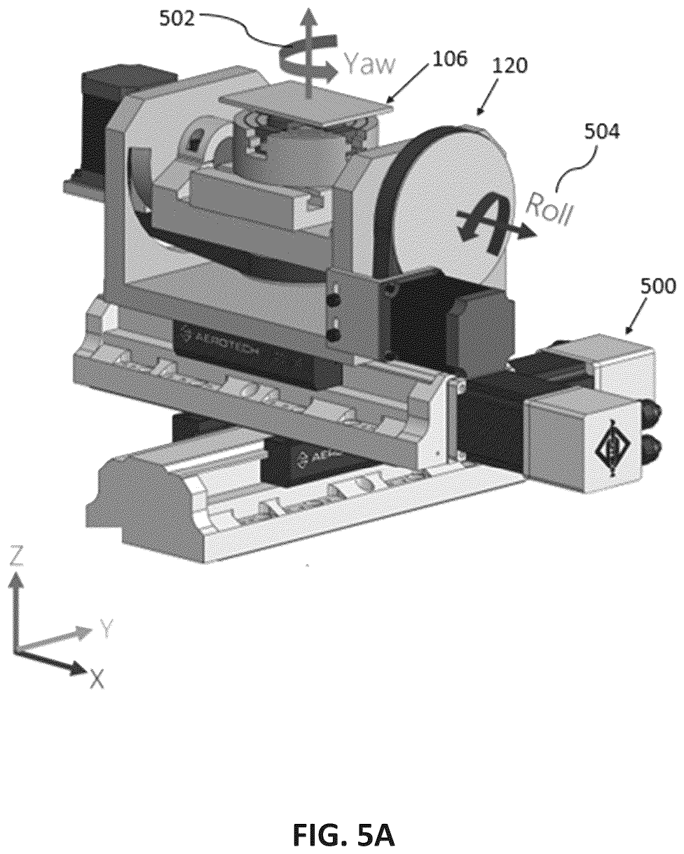

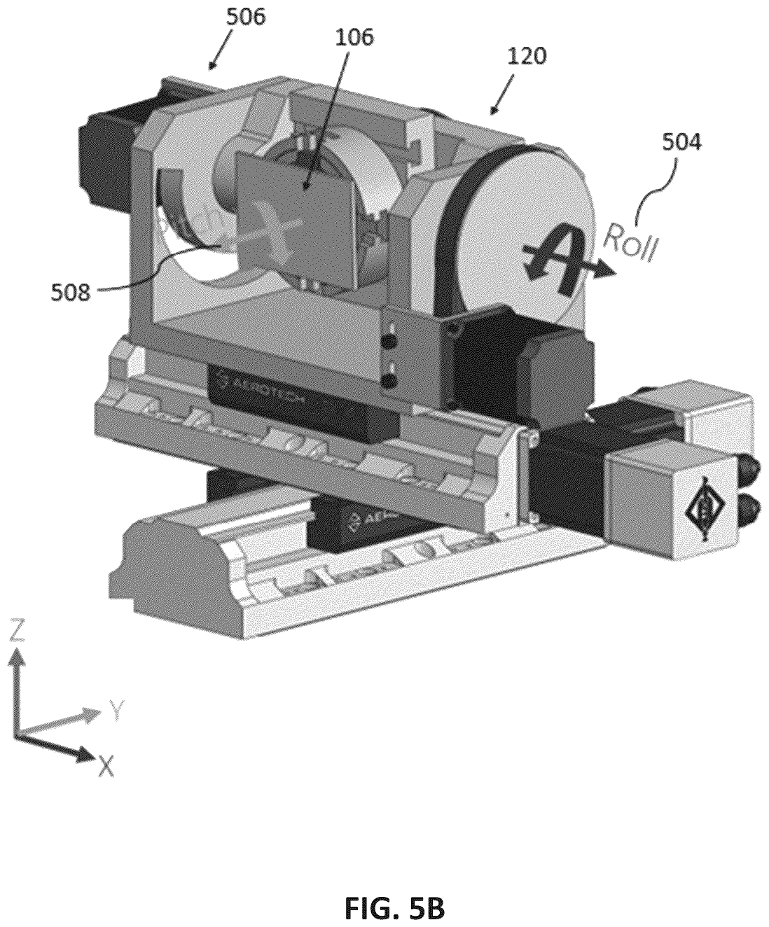

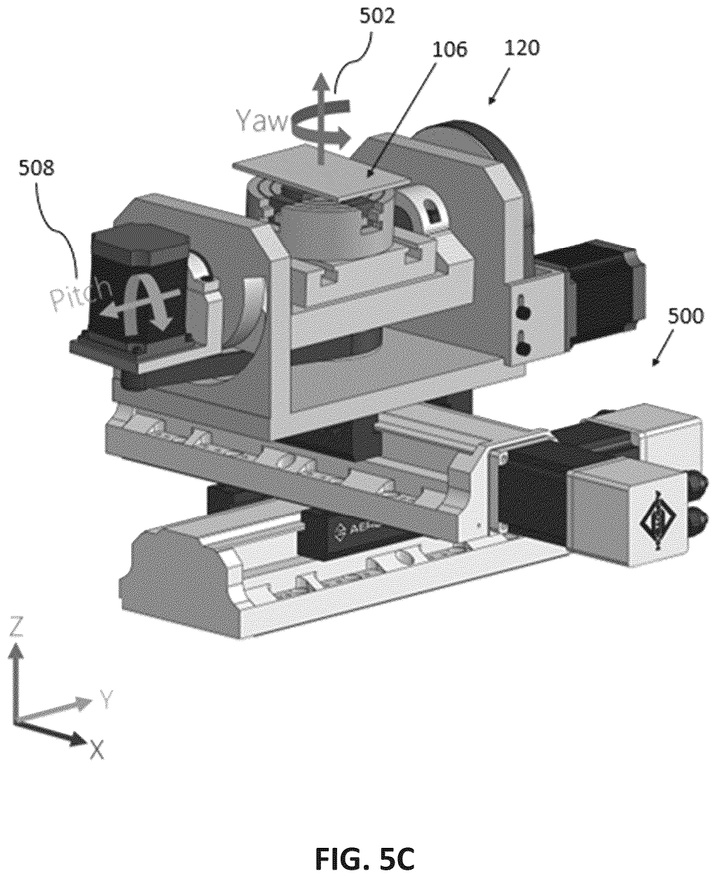

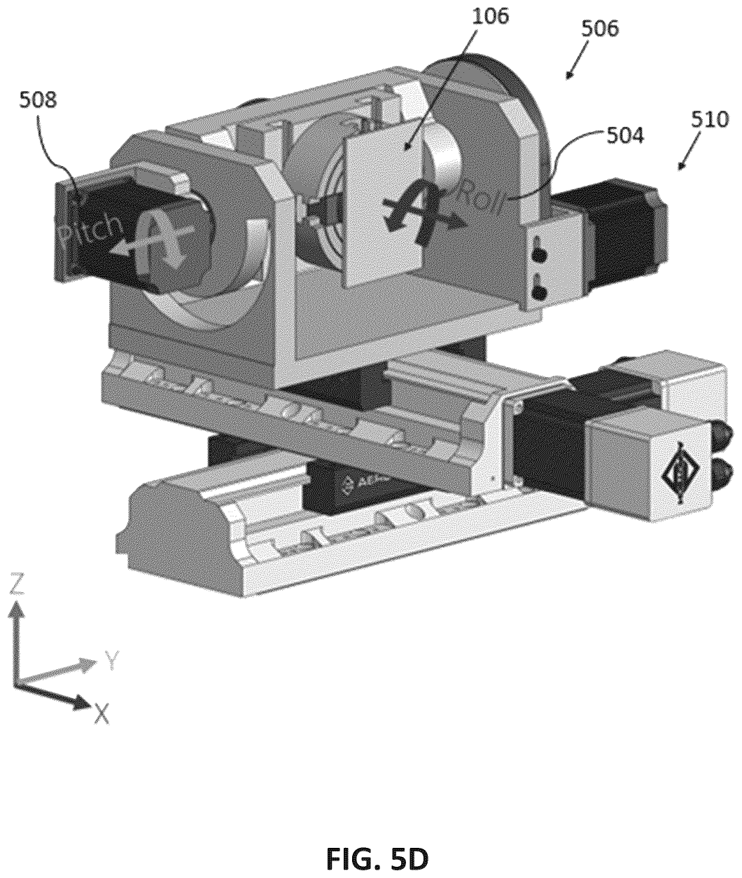

FIGS. 5A-5D show example illustrations of the trunnion mechanism 120 incorporated in the MEW system 100 to increase the printing rotational freedom. The MEW device 102 is being modified to incorporate 1 or 2 extra rotational axes (via the trunnion mechanism 120) to the collector positioning system (the XY axis positioning system 112) and/or the print-head positioning system (the Z axis positioning system 110). The MEW device 102 can go from printing on flat collectors to curved, non-circular cross-sectional and/or bifurcating tubular collectors because of the additional mechanical degrees of freedom achieved via the incorporation of the trunnion mechanism 120.

The trunnion mechanism 120 can be arranged in advance on a positioning system depending on suitable setups to maintain orthogonality between the print head 104 and the surface of the collector 106. Up to four different setups (FIGS. 5A-5D show four different setups) could be achieved to work in each plane, e.g., the XY plane, the XZ plane, and the YZ plane. This modular capability of coupling the trunnion mechanism 120 to a suitable positioning system, would allow great flexibility for the fabrication of complex geometries.

FIG. 5A shows an example setup to allow a rotation of the XY plane based on the two extra rotation axes yaw and roll. In particular, the trunnion mechanism 120 coupled to a XY axis positioning system 500 enables two extra rotation axes, yaw 502 and roll 504 to allow printing on out-of-plane surfaces while maintaining an orthogonal relationship between the print head 104 and the surface of the collector 106.

FIG. 5B shows another example setup to allow rotation of the XZ plane based on the two axes of rotation pitch and roll. In particular, the trunnion mechanism 120 coupled to a XZ axis positioning system 506 enables two extra rotation axes, a pitch 508 and the roll 504 to allow printing on out-of-plane surfaces while maintaining an orthogonal relationship between the print head 104 and the surface of the collector 106.

FIG. 5C shows another example setup to allow a rotation of the XY plane (similar to the example in FIG. 5A) based on the two axes of pitch and yaw. In particular, the trunnion mechanism 120 coupled to the XY axis positioning system 500 enables two extra rotation axes, the pitch 508 and the yaw 502 to allow printing on out-of-plane surfaces while maintaining an orthogonal relationship between the print head 104 and the surface of the collector 106.

FIG. 5D shows another example setup to allow a rotation of the YZ plane based on the pitch and roll rotation axes. In particular, the trunnion mechanism 120 coupled to a YZ axis positioning system 510 enables two extra rotation axes, the pitch 508 and the roll 504.

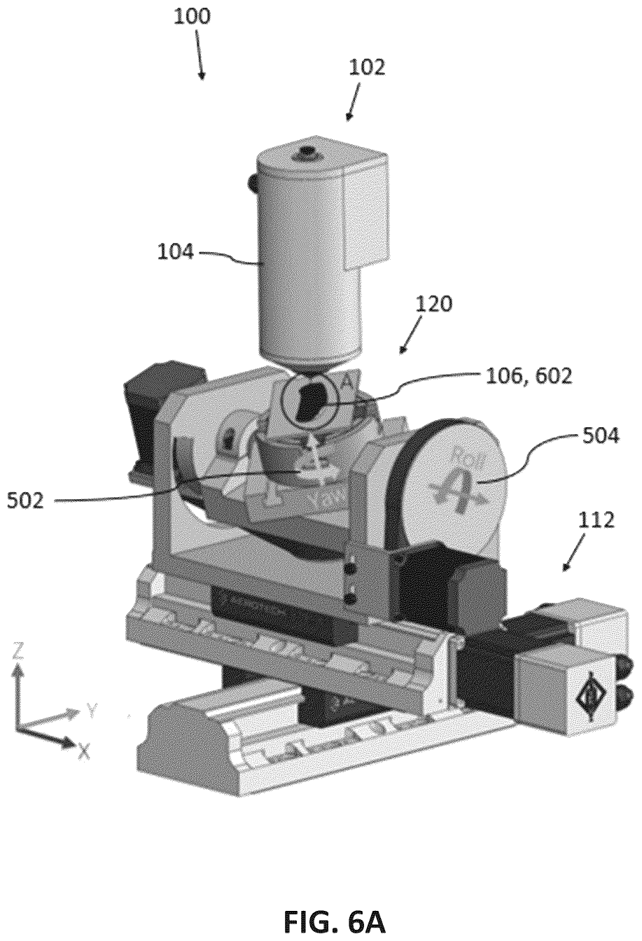

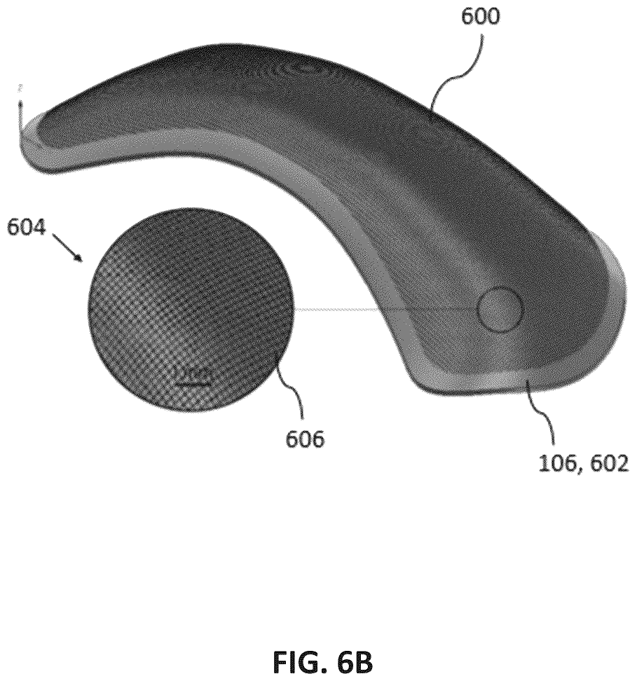

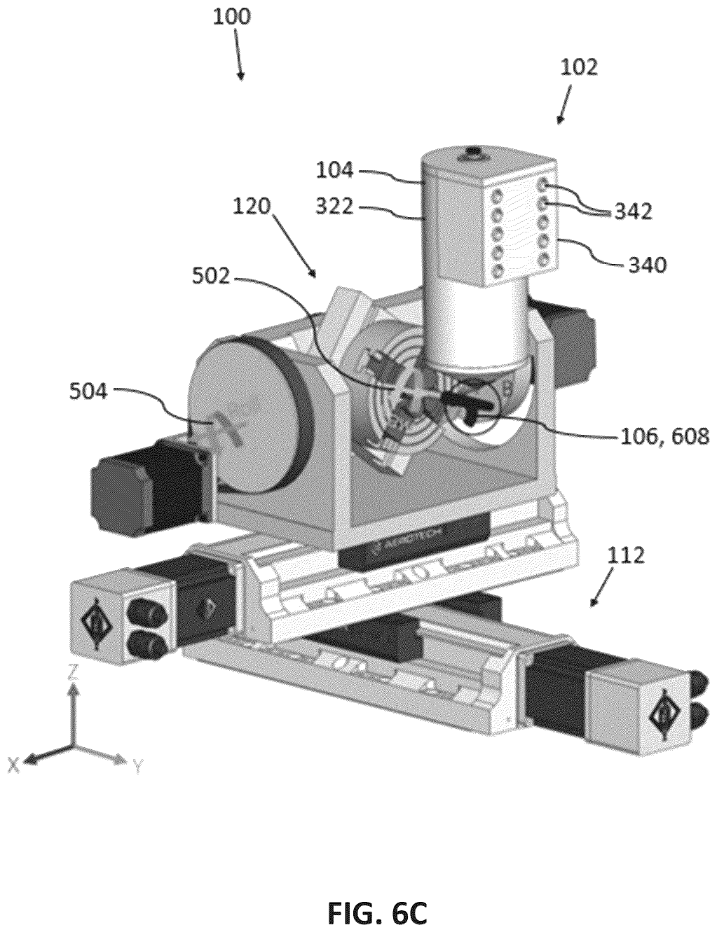

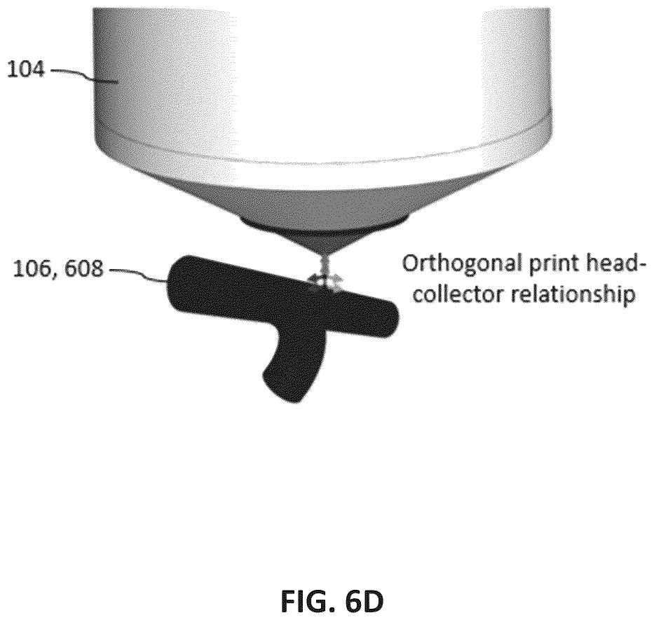

FIG. 6A shows an example of the trunnion mechanism 120 coupled to the XY axis positioning system 112. The trunnion mechanism 120 enables two extra rotation axes, yaw 502 and roll 504 to allow printing on out-of-plane surfaces while maintaining an orthogonal relationship between the print head 104 and the surface of the collector 106.

FIG. 6B shows an example generation of the toolpath for printing thin membranes 600 on a collector 602 of a knee cartilage geometry. In a detailed view 604, the pore size of the membranes 606 is approximately 250 micrometers (μm) printed using the MEW device 102 in FIG. 6A.

FIG. 6C shows another example of the trunnion mechanism 120 coupled to the XY axis positioning system 112. The trunnion mechanism 120 enables the two extra rotation axes, the yaw 502 and the roll 504 to allow printing on out-of-plane surfaces while maintaining an orthogonal relationship between the print head 104 and the surface of the collector 106. In the perspective view shown in FIG. 6C, the back side 340 of the housing 322 contains inserts 342 for screws (e.g., M6 screws) so it could be attached to a mount to the Z axis positioning system 110 or attached to an end effector of the robot 122.

FIG. 6D shows an example orthogonal print head-collector relationship for printing on a collector 608 of a bifurcated tubes geometry.

With the addition of the trunnion mechanism 120, the MEW system 100 is capable up to 5-axis additive manufacturing processes. The MEW system 100 is configured to achieve capabilities to fabricate anatomically relevant geometries by maintaining an orthogonal print head-collector relationship with out-of-plane collector surfaces.

Furthermore, the MEW system 100 may include a digital twin based on the MEW device 102 to use Computer Aided Manufacturing (CAM) techniques. In this manner, the MEW system 100 is able to simulate the kinematics of the printing process, generate toolpaths and G-Codes from any design, and plan ahead for the manufacturing of a variety of medical devices. Other advantages include path optimization to reduce manufacturing times, ease of modification of the desired pore size by stepover, and post-processing of toolpaths with different orientations and geometries. The predicted set-up of these variables would allow control of the resulting mechanical properties, such as the demonstrated effect of fiber orientation on the burst strength.

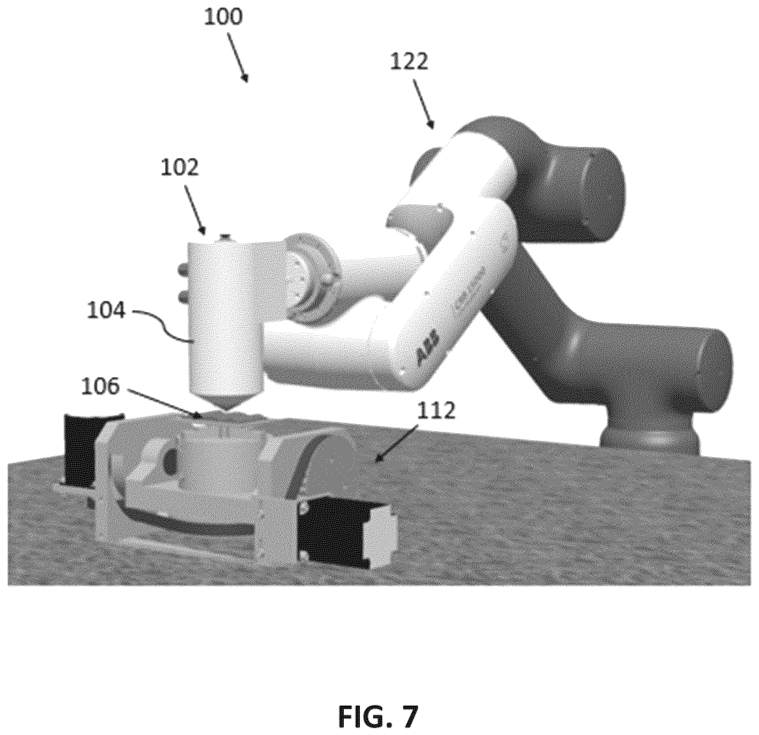

FIG. 7 shows an example MEW system 100 with the robot 122 (a 6-axis collaborative robot). The robot 122 is configured to control the print head 104 to provide up to six mechanical degrees of freedom to enable printing trajectories in a realistic way. For example, the MEW system 100 with the robot 122 is configured to print thin membranes on a configurable collector 106. The collector 106 is “configurable” in the way that the collector 106 have realistic structures of anatomical geometries (e.g., cornea, bifurcated vascular grafts, knee meniscal cartilage and other joint surfaces, or virtually any curved organ surface).

By collaborating robots (e.g., the robot 122) and/or combining the MEW device 102 with other modalities, such as chaotic printing, the fabrication of structures with thin membranes or other complex geometries can be achieved. The print head 104 may be operated by a chain of interconnected linear or rotating robots or a single high degree of freedom robot to accomplish 3D printing onto curving surfaces of complex fiber collectors. It is known that weaving angle can affect the mechanical properties of the printed object. The MEW system 100 with a high modularity to achieve high mechanical degrees of freedom can overcome challenges faced in conventional MEW systems. For example, one of the challenges to print on a curving tube is to find a realistic way to move axis of rotation to keep an orthogonal relationship between the surface of the collector 106 with the nozzle of the print head while printing on surfaces weaving in and out of XY, YZ, or XZ planes. If the nozzle of the print head and the surface of the collector 106 are not aligned orthogonally during the MEW process, the applied electric field is disturbed and unstable, which prevents the orderly deposition of fibers. Another challenge is to compensate spinning motion for printing on a collector 106 having a non-circular cross-section. Still another challenge is to compensate for bifurcating tube(s) as each branch of which would have a new axis of rotation. The MEW system 100 overcomes these challenges by coupling the trunnion mechanism 120, which would allow aligning the surface of the collector 106 to a suitable plane (e.g., the XY plane, XZ plane, or YZ plane) and/or using the robot 122 to increase the printing rotational freedom.

Furthermore, outside of chaotic printing, it is not possible for a conventional MEW device to print thin membranes as curving surfaces. It is also not possible for a conventional MEW device to seed the membranes with different types of cells, which is necessary to bring about most organ function. Printing an organ can not be achieved unless one can position these layers that follow these curving surfaces directly opposed (adjacent) to one another. The MEW system 100 may be used in combination with chaotic printing techniques to print a hydrogel construct that can deliver cells in thin layers. A fiber weaving strategy for printing scaffolds can be applied as a strategy to make larger tissues, if not eventually whole organs, that can hold their own shape. Stiffening of hydrogels may prevent cells from functioning whereas strategically placed fiber woven “skeletal” membranes could solve many if not most biofabrication structural needs.

The MEW system 100 is not limited to use one robot. Collaboration of robots (e.g., multiple print heads and/or multiple collector-moving robots) as well as collaboration of other print modalities enables depositing cells simultaneously or after weaving a layer.

In practice, it is beneficial to align orthogonally both the print head and the surface of the curved collector 106 to prevent the electrical field to be unstable instead of printing in misalignment and then accommodating the effects of being unaligned. Such alignment may be done by first aligning the collector 106 and then positioning the print head 104 over the aligned surface. In this way, the normal force of the electric field would be orthogonally aligned between the print head and the curved surface. Thus, the extruded fibers influenced by the normal of the electric field would be deposited in an orderly fashion by the predefined path of the G-Code.

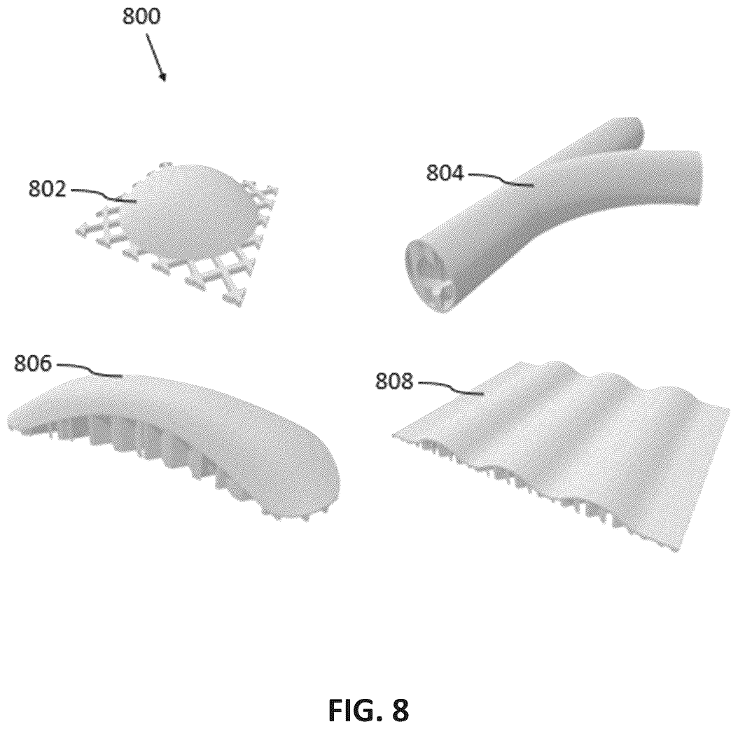

FIG. 8 shows examples of the configurable collectors 800 including a configurable collector 802 with geometries of a lattice base for cornea, a configurable collector 804 with geometries of bifurcated vascular grafts, a configurable collector 806 with geometries of knee cartilage, and a configurable collector 808 with geometries of curved surfaces. In the configurable collectors 800, the inner space below the surface allows the electric field to permeate. The surface of the configurable collectors 800 would have a thin layer of material (either resin or conductive metal) and a lattice base to allow the electric field to permeate, thus making fiber deposition feasible.

A controlled cooling/heating system may be added in the collector (the collector 106 or the configurable collector) to print materials with different melting points in the same construct. In this way, deposition of fibers of one material with higher melting point would not damage the lower fibers of the other material (with lower melting point).

The advantages of the MEW system 100 are discussed below. Some of the advantages arise from how the structure is designed and built, as it can be adaptable to other devices with 3 or more additional axes. The constituent materials protect the internal components from the electromagnetic field applied in the MEW process and protect the users from the high temperatures in the heating chamber 308. The back side 340 of the housing 322 contains the inserts 342 for screws, so it could be attached to the mount of the Z axis positioning system 110 or the end effector of the robot 122.

The capability to easily change different needle 318 couplings also provides great flexibility, as gauges from G14 to G30 can be used to test materials with different rheological properties. The conical shape of the ring (the conical interchangeable ring 334) and the lower protector (the conical lower housing 336) offer advantages by avoiding collisions with the collector (the collector 106 or the configurable collector) during fiber deposition over out-of-plane and curved surfaces. This also opens up the possibility of the print head 104 to be used with other manufacturing techniques, such as hydrogel printing or electrospinning. The components of the housing 322 are magnetically attached to each other, so it is easy to remove them to change syringes (the syringe 300), rings (the flat interchangeable ring 330 and the conical interchangeable ring 334), or adding new/different polymers.

The device mechanisms of the MEW system 100 are configured to imitate the kinematics of up to 6-axis manufacturing processes. The addition of 2 rotary axes to the XYZ positioning system (the Z axis positioning system 110 and the XY axis positioning system 112) would provide manufacturing capabilities for anatomically complex out-of-plane geometries. The collaborative robots (the robot 122), CAD/CAM techniques and the use of configurable collectors (the configurable collectors) are expected to bring other outstanding capabilities, such as the manufacturing of highly customized medical devices.

The acrylic enclosure and mechanical components, such as linear guides (the linear guides 402) and the print head 104 are easy to clean and disinfect for working in a sterile environment, so that different types of cells can be dispensed during fabrication of multiple layers.

The MEW system 100 is configured to have the capabilities to produce thin membranes of different pore sizes for tissue engineering applications (TE). Polycaprolactone (PCL) membranes with pore sizes of 250 μm to 1000 μm, 250 μm to 500 μm, about 250 μm, can be fabricated by the MEW system 100 with highly ordered, straight, and stacked fibers of up to 19(+2.6) μm. By modulating the MEW parameters, such as collector speed and extrusion pressure, the diameter of the printed fibers may be in the range of 19 to 50 μm. In some embodiment, the pore size of the object produced by the MEW system 100 may be as small as 10 μm.

A critical capability of MEW-rendered vascular structures is to render vascular grafts with features common to mammalian, as well as non-mammalian, vascular or other biological conduits anatomies that are currently unavailable in any thin membrane forming technology. The MEW system 100 can produce vascular meter-micron level anatomies, curving tubular structures, non-circular cross-sectional tubular structures, bifurcating tubular structures, etc. The MEW system 100 is able to maintain an orthogonal relationship between the axis of rotation and the print head 104 with any geometry and surface profile (curving surfaces). This benefits the stability of the electric field used during MEW to achieve an orderly and stacked deposition of fibers. The MEW system 100 is able to print with up to six mechanical degrees of freedom.

The MEW system 100 is able to produce multiple thin membranes for different cells and extracellular matrix-relevant components that can instantiate complex membranes that are parts of organs or organelles. These curvatures are clearly necessary to bring about function in orthopedic, vascular, and other organs where the close adjacency and interaction of thin membranes (especially adjacent thin membranes populated with different types of cells) is required for normal organ function to occur (e.g., blood vessels, kidney, lung, liver, eye, etc.). Prominent examples are the thin membranes which allow joint surfaces, the retina, alveoli in the lung, neural synapses, digestive structures, immunological assessment, and liver fat storge/blood filtering to function normally. The basis of all organismal and organ function can be said to rely, at least initially, on the adjacency of thin membranes of two or more types of cells with differing functions to work together to accomplish tissue or full organ-level function.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

1. A melt electrowriting (MEW) system, comprising:
an MEW device configured to print a material on a collector, wherein the MEW device comprises:
a print head configured to melt and extrude the material out from an extruder, wherein the extruder is exchangeable depending on a surface profile of the collector; and
a positioning system configured to coordinate movements of the collector relative to the print head, wherein the MEW system is configured to print the material with at least four mechanical degrees of freedom and up to six mechanical degrees of freedom.

2. The MEW system of claim 1 comprising a trunnion mechanism integrated with the positioning system to enable rotations of the collector relative to the print head along a yaw axis and along a roll axis, or along a pitch axis and along the roll axis.

3. The MEW system of claim 2, wherein the print head is integrated in a Z axis of the positioning system.

4. The MEW system of claim 2, wherein the trunnion mechanism is integrated in a XY axis of the positioning system.

5. The MEW system of claim 1 comprising a six-axis collaborative robot coupled to the print head or the collector to move the print head and the collector relative to each other with up to six mechanical degrees of freedom.

6. The MEW system of claim 1, wherein the extruder is exchangeable between a flat extruder configured to print on a flat surface profile and a conical extruder configured to print on a curved surface profile.

7. The MEW system of claim 1, wherein the positioning system is configured to maintain an orthogonal print head-collector relationship with out-of-plane collector surfaces.

8. The MEW system of claim 1, wherein the print head comprises:
a syringe with a needle configured to contain the material;
a heating chamber configured to receive the syringe and the needle and provide heat to the syringe and the needle via cartridge heaters; and
a thermally insulative layer that wraps around the heating chamber.

9. The MEW system of claim 1 is configured to print the material on the collector with geometries of a lattice base for cornea, bifurcated vascular grafts, knee cartilage, or curved surfaces.

10. The MEW system of claim 1 is capable of printing on the collector of a curving tubular structure.

11. The MEW system of claim 1 is capable of printing on the collector of a non-circular cross-sectional tubular structure.

12. The MEW system of claim 1 is capable of printing on the collector of a bifurcating tubular structure.

13. The MEW system of claim 1 is capable of printing membranes with pore sizes as small as about 10 μm.

14. A process of melt electrowriting (MEW) on a collector using a MEW system comprising a print head configured to melt and extrude a material out from an extruder, and a positioning system configured to coordinate movements of the collector relative to the print head, wherein the process comprises:
swapping a flat extruder with a conical extruder and printing on out-of-plane collector surfaces; and
maintaining an orthogonal print head-collector relationship with the out-of-plane collector surfaces during printing.

15. The process of claim 14 comprises rotating the print head relative to the collector along a yaw axis and along a roll axis, or along a pitch axis and along the roll axis during printing using a trunnion mechanism integrated with the positioning system.

16. The process of claim 14 comprises moving the print head or the collector relative to each other with up to six mechanical degrees of freedom during printing using a six-axis collaborative robot coupled to the print head.

17. The process of claim 14 comprises printing on the collector of a curving tubular structure.

18. The process of claim 14 comprises printing on the collector of a non-circular cross-sectional tubular structure.

19. The process of claim 14 comprises printing on the collector of a bifurcating tubular structure.

20. The process of claim 14 comprises printing on the collector with geometries of a lattice base for curving organ surfaces comprising bifurcated vascular grafts, knee cartilage, and/or other curved surfaces.
